(19) United States
(12) Patent Application Publication
(10) Pub. No.: US 2010/0271480 A1
(43) Pub. Date: Oct. 28, 2010

(54) Vehicular surveillance system

(76) Inventor: Leonid Bezborodko, Bronx, NY (US)

Correspondence Address: Leonid Bezborodko, 1634 Tomlinson Avenue, Bronx, NY, 10461, US

(21) Appl. No.: 11/657,986

(22) Filed: Jan. 25, 2007

Related U.S. Application Data
(60) Provisional application No. 60/762,331, filed on Jan. 27, 2006.

(51) Int. Cl. H04N 7/18

(52) U.S. Cl. 348/148; 348/E07.091

(57) ABSTRACT

An on-board vehicular surveillance system for an occupied or unoccupied host vehicle is configured to capture and record car-accident related events caused by a target vehicle or any other object by at least one hidden recording camera. The camera is camouflaged for or incorporated in at least one of the standard accessories of the host vehicle and, thus, is hardly identifiable from outside.

### CROSS-REFERENCE TO RELATED APPLICATION

This application claims priority to U.S. application Ser. No. 60/762331 filed with the U.S. Patent and Trademark Office on Jan. 24, 2006 and fully incorporated herein by reference.

### BACKGROUND OF THE INVENTION

1. Field of the Invention

This invention relates to vision systems for vehicles, and more particularly relates to a vehicular accident-recording vision system camouflaged for one of standard accessories within a passenger compartment to provide a vehicle operator with car-accident related information.

2. Prior Art

One of many causes of frustration for a car driver/owner is his inability to identify and record events leading to a car accident and caused by another vehicle or object. Whether or not a car accident occurs when a car is driven or parked, the cost for repairing car damages caused by another vehicle often falls on an innocent car driver or car owner who is unable to identify and locate a real culprit.

A variety of effective surveillance systems are known in the art. Typically, these systems are configured with one or more displaceable cameras located to have a field of view directly capturing events occurring around a vehicle. The complexity of many of these systems is often reflected by their cost.

Also, many of the known designs are easily visible from outside negating thereby the concept of camera undistinguished. As a consequence a malfeasant can be easily warned and damage a car while avoiding the possibility of being captured by these systems.

A need, therefore, exists for a surveillance recording system which enables a driver to be informed about a potentially dangerous situation on a road, identify a vehicle and/or object that caused an actual car accident or damage to the driver's car, and have a recorded information regarding a car accident.

A further need exists for a cost-effective car-recording system having a simple configuration camouflaging the recording system for one of standard car accessories.

### SUMMARY OF THE INVENTION

These needs are met by a surveillance recording system installed in a vehicle and operable to capture and record the image of another car or an object that caused a car accident in response to a signal generated by a sensory unit. The sensory unit is operable to detect the presence of the other car or object before, during and after the accident has occurred. Advantageously, the car-recording system including a photo/video-camera with synchronous sound recording feature is enclosed within a standard accessory, such as, a taillight.

In accordance with one embodiment of the invention, the inventive recording system comprises a reflective mirror or prism installed in the passenger compartment of a host vehicle at a predetermined location allowing the mirror to continuously reflect events that occur in front and/or behind the car. The images captured by the mirror while incident are reflected to a camera which is operable to capture and record the images and sounds. Preferably, the camera operates in an event-driven mode, such as a collision or motion which is detected by a variety of sensory devices including motion and acceleration/shock or and deflection sensors.

In another aspect, the inventive surveillance recording system is configured with a plurality of reflective mirrors mounted in the car passenger compartment so as to provide front, rear and side images of events occurring while a host vehicle is either driven or parked. The camera and/or mirrors are positioned to have respective images of outside events incident on the lens of a photo/video-camera which is mounted in the passenger compartment and enclosed in one of the standard car accessories including a taillight.

According to a further embodiment of the invention, at least one mirror is installed in the passenger compartment of a host vehicle in a position allowing for capturing a license plate portion of another vehicle. The image of the license plate is reflected onto a camera which captures its number. An on-board central processing system or controller is operable to automatically establish the predetermined position of the mirror if the latter has been inadvertently displaced. Advantageously, the mirror is installed so as to have a predetermined angle relative to the axis of symmetry of a vehicle which is selected to capture a license plate region of vehicles in front, aside of and behind the host vehicle.

In still a further aspect of the invention, the inventive surveillance recording systems may be configured with controller executing software not only for recording a license plate's number, but also for generating sound signals corresponding to each of the recognized icons on the license plate. Having a sound recording unit provides the inventive system with a means for duplicating a vital information regarding an accident and its participants.

The inventive surveillance recording system may have a means for communicating a data regarding a potentially threatening situation to a remote location in real time. The remote location may be, in turn, linked to a corresponding law enforcement or traffic control unit and a medical facility which can be mobilized in a short period of time to fulfill their respective duties based on the transmitted image and sound recording of the accident.

The above and other features and advantages of the present invention will become more readily apparent from the following specific description in conjunction with accompanying drawings.

### BRIEF DESCRIPTION OF THE DRAWINGS

FIG. 1 is an elevational side view of a vehicle provided with an inventive surveillance recording system;

FIG. 2 is a simplified diagram illustrating the sensory and control unit of the inventive system;

FIG. 3 is a flow chart illustrating the operation of the inventive system;

FIG. 4 is a diagrammatic view of illustrating an operation of a controller; and

FIG. 5 is a diagrammatic view of a network configured in accordance with the present invention.

### SPECIFIC DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. The words “connect,” “couple,” and similar terms do not necessarily denote direct and immediate connections, but also include connections through intermediate elements or devices.

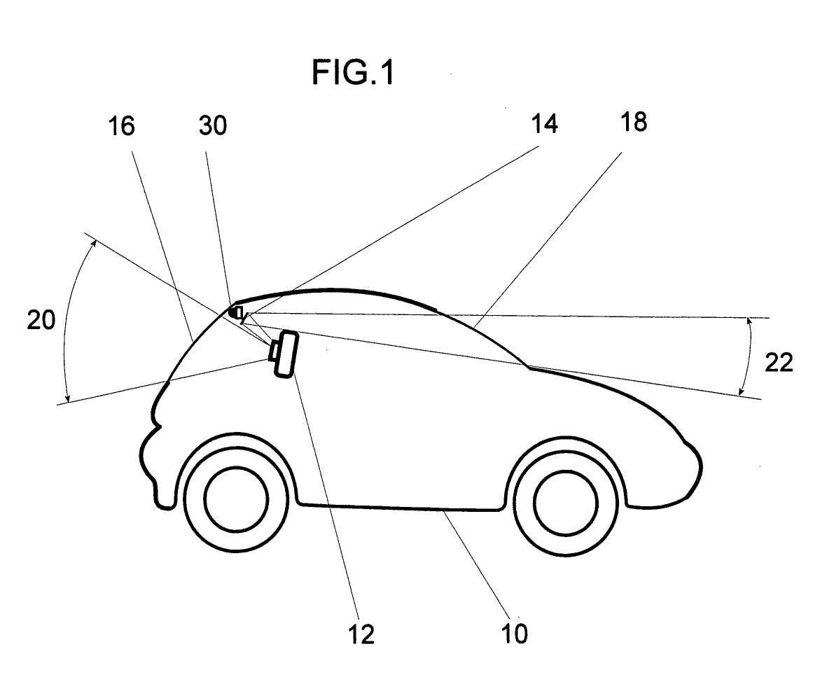

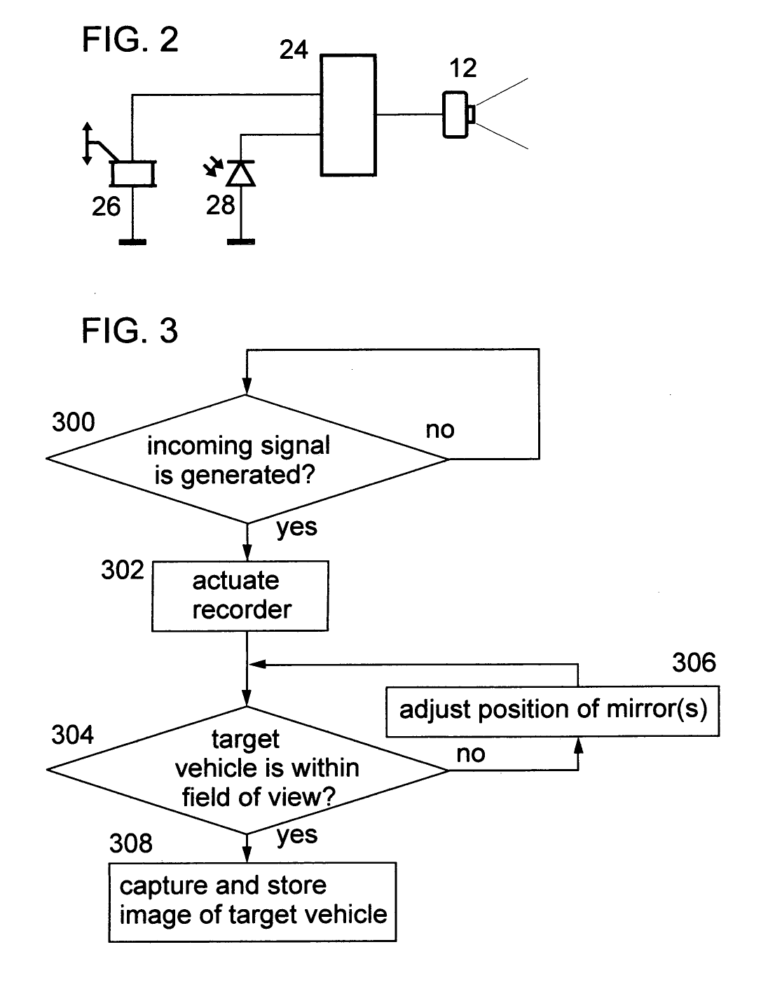

Referring to FIG. 1, a vehicle 10 is provided with the inventive surveillance recording system operable to record events accompanying a car accident. The inventive system includes at least one recording component 12 mounted in a passenger compartment. In addition, the inventive system may include at least one mirror or prism 14. The mirror 14 is, for instance, a frontward view mirror having a mirror plane aimed to capture events within its field of view 22 occurring at a relatively small distance from the front of vehicle 10. An array of sensors 26, 28 (FIG. 2) is operable to generate a triggering signal in response, for example, to an impact produced by a target vehicle (not shown). The incoming signals or signal are received and processed by an on-board controller 24 which, in turn, is operative to generate a control signal capable of actuating camera 12. Upon being turned on or switched to an ON-mode of operation, camera 12 is operable to capture images and sounds which are incident thereupon from mirror 14 and/or occur directly within a camera filed of view 20. The entire operational sequence of the inventive system, as briefly discussed above, allows for capturing the surveillance event can be captured in real time. Preferably, mirror 14 is aimed on the rearward region of the target vehicle including a license plate.

To prevent the inventive system from being easily detected by a malfeasant, the inventive system is advantageously housed in a casing of one of the standard car accessories. In accordance with one embodiment of the invention, camera 12 is enclosed in a housing 30 of the taillight. Using this modification, the presence of mirrors may not be necessary since the camera can be focused so as to directly capture events related to vandalism or car accident occurring within a camera field of view 20. The housing 30 of taillight 16 may be made from a one-way mirror to provide the camera with the desired field of view but, at the same time, making the camera invisible from outside. One of possible modifications of the invention is illustrated by a photograph attached herewith and fully incorporated as an integral part of the present disclosure. Alternatively, camera 12 may be housed within a casing of ceiling or top light. The camera 12 is configured as a still film camera or CCD/CMOS digital camera.

The mirror 14, if necessary, may be mounted inside or outside the car compartment. For example, capturing events in front of vehicle 10 can be realized by front-view mirror 14 located within the housing of taillight 30, suspended to the rear-view window or to any other location of the passenger compartment. The mirror 14 and camera 12 are so positioned relative to one another that images within the mirror's field of view are incident upon the lens of camera 12 which thus may simultaneously capture the rear-view, front-view and side-car events by using a well known multiplexer.

Mounting of mirror 14 to the rear-view window or car roof can be realized by a variety of coupling means including, for example, suction cups attached to the rear window. Preferably, a mirror mount includes an arm provided with a universal joint (not shown) which is pivotally coupled to mirror 14. Unless the mirror is accidentally displaced out of focus, it is mounted in a predetermined position that allows capturing a target vehicle that either has been hit by or has hit host vehicle 10. A pivoting mount structure allows the vehicle operator to manually or automatically, as will be explained below, reestablish the desired position in which the reflected event or events are incident upon the lens of recording component 12.

The mirror 14 and lens of camera 12 can have any of the known designs including, for example, a convex, dome-shaped or prismatic shape. Having any of the above-mentioned shapes provides a panoramic view of all four sides of vehicle 10 thereby eliminating or minimizing the need for another mirror or mirrors. Proper positioning of single mirror 14 allows for capturing events occurring behind vehicle 14 and along its other sides.

Alternatively, a second minor or minors 14 as well as cameras 12 may be positioned to have the field of view which captures the combined image of events occurring, for example, ahead and behind vehicle 10, as shown in FIG. 1. Installation of additional mirrors does not alter the configuration of the inventive system, because camera 12 may be oriented within the housing of taillight 30 to have its lens located so as to capture images reflected off multiple mirrors.

A sensory system detecting an event may include a variety of differently configured sensors 26 and 28 (FIGS. 1 and 2). If the sensory system is operable to detect motion, the inventive system can have motion detectors sensing and reporting human or vehicle motion near the rear, front or sides of vehicle 10. The sensor 26 detects acceleration/shock actions while sensor 28 is configured to optically detect motion. One of possible configuration of sensors 26, 28 allows for transmitting high frequency radio wave signals into controller 24. Other motion detection configurations may use infrared light (IR) to detect heat changes, such as when a person (body heat) walks by the infrared sensors. Still other motion detection systems use lasers and photoelectric beams. If this light beam is interrupted, an incoming signal is generated and received by a controller 24 operating camera 12, as will be explained below.

Alternatively or in addition the above discussed motion-detection configurations, the sensory system is operable to detect an impact upon host vehicle 10 by acceleration/shock detecting sensor 26. The impact detector 26 generates an electrical indication, either the voltage, conduction or current, as in the touching of contacts, or a change in capacitance, or the generation of a logical signal, upon impact of the projectile such as vehicle or pedestrian.

Other types of a sensory system may include inertia switches which are advantageous because they do not require a power source. Upon impact, vehicle 10 may accelerate (or, conversely, decelerate) in any direction which triggers actuation of the inertia switches. Still a further configuration of a sensory system contemplated within the scope of the present invention includes a technology used to measure deflection of body of the vehicle, displacement of parts in opposite directions and range of motion. This technology is highly sensitive and can, for example, measure the impact of the vehicle's bumpers on a human leg.

Regardless of the type of the sensory system utilized by the present invention, the location of sensors 26 and 28 may be selected among a variety of ways. For example, an array of sensors 28 may be employed along a perimeter of vehicle 10. Other implementations may include mounting a sensor within the same housing that encloses camera 12.

Having detected a triggering event, sensors 26 and 28 generate a triggering signal received by controller 24. The controller 24 may be configured as a processor constantly analyzing signals of sensors which is operable to perform the programmed tasks. For example, camera 12 may be turned ON, OFF or operate in a sleep mode. Upon receiving a triggering signal generated by one or more sensors 26, 28, controller 24 outputs a control signal actuating camera 12.

Referring to FIG. 3, the algorithm executable by controller 24 is configured to perform various additional operations. Once the triggering signal indicating detection of a suspicious event is received, as indicated by a step 300, camera 12 is controllably actuated. A triggering signal may be a combination of two or more relatively weak signals indicating the persistence of the suspicious event or one relatively strong signal from one of sensors. The inventive system is configured to not respond to a single relatively weak signal indicating no more than an accidental non-damaging contact with the host vehicle. The controller 24 is configured with a database (not shown) storing predetermined frames. For example, the database may have frames corresponding to small-, medium- and large-size vehicle. The camera 12 (FIGS. 1 and 2) may automatically modify its angle upon actuating a stepper motor (not shown) to provide the best possible field of view corresponding to the size of the detected target vehicle. Preferably, camera 12 has a predetermined position depending on a distance between host vehicle 10 and a target vehicle and the size of the latter, as indicated by step 304. The predetermined position of camera 12 may be selected so that the license plate of the target vehicle is automatically captured. If mirrors 14 are used, and the controller determines that the target vehicle is not within a filed of view, mirror actuators, such as stepper motors, may be actuated to displace the mirror or mirrors, as shown by a step 306, so that camera 12 is operable to capture the image of the license plate of the target vehicle reflected by properly positioned mirrors 14 or directly captured by camera 12. Alternatively, instead of displacing mirror or mirrors 14, camera 12 may be displaced to capture images reflected off the reflective plane of mirror or mirrors 14.

Additional features include, for example, turning on a rear side light and/or a front side light illuminating a respective region. If host vehicle 10 is provided with a GPS system, the latter may be actuated to output a signal carrying the location along with video and audio identification signals of a target vehicle to an information center, as is explained below.

Furthermore, controller 24 may execute a software operable to recognize written icons, for example, a license plate number, and generate a sound signal corresponding to the letters and numerals on the license plate of the target vehicle. The sound signal is further recorded and either stored along with a captured video signal, as shown by a step 308 (FIG. 3), or transmitted to an information center.

While the above discussion involves recording the images of a target vehicle, any object including a human being, who either incidentally or maliciously contacts host vehicle 10, can be detected by the inventive system.

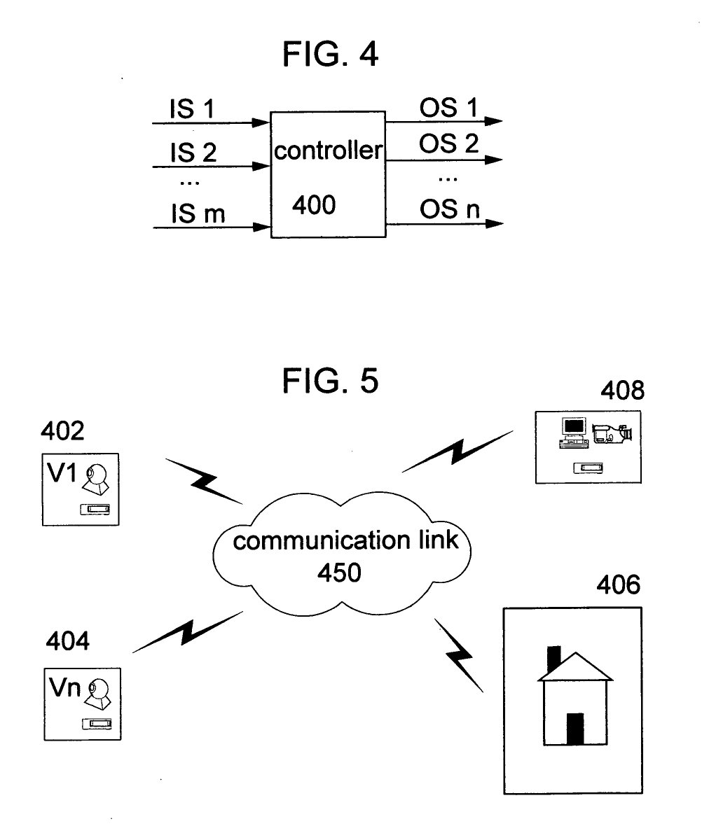

FIG. 4 illustrates the operation of the inventive system in a highly simplified form. A single or multiple incoming signals IS1 . . . ISm are generated by respective sensors 26, 28 and are received by controller 400. Depending upon a software executed by controller 400, multiple output signals OS1 . . . OSn are generated by the controller to actuate camera 12, correct the position of the camera and/or mirrors 12, turn on various lights, communicate with a remote information center and to perform other function as discussed above.

FIG. 5 illustrates one of possible communication modes of the inventive surveillance system. For example, each of multiple vehicles 402, 404 provided with the inventive system is coupled to a communication link 450 such as Internet or any other global communication system. Having recorded or during recordation of a triggering event, the inventive system is operable to transmit images and sound signals carrying the information of the event to a remote control center 406. The center 406 is, in turn, using communication link 450 or any other possible communication link, may connect to a law enforcement and/or medical aid facility 408, which in turn, may dispatch mobile units to arrive at the scene within a short time period.

The inventive system may have a modular design in accordance with which each component of the system may be separately purchased and installed. Alternatively, the scope of the invention also includes manufacturing and distribution of a kit having all or at least some of the components of the inventive system.

The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. For example, controller 24 and 400 shown in FIGS. 1 and 4, respectively, has CPU, ROM, RAM and other components well known to an artisan in the relevant art. Local connectivity between the controller and a variety of sensor/appliances can be achieved by wired connections, but preferably by wireless analogue or digital connections. The illustrative examples therefore do not define the metes and bounds of the invention.

1. A vehicular surveillance system, comprising a recorder operable to capture and record car-accident related events and mounted in a housing of a standard car accessory within a passenger compartment of a host vehicle.

2. The system of claim 1, wherein the standard car accessory comprises a taillight.

3. The system of claim 1, wherein the standard car accessory comprises a ceiling light.

4. The system of claim 1, wherein the recorder comprises a photo/video-camera with sound registration.

5. The system of claim 1, wherein the recorder includes a CCD/CMOS.

6. The system of claim 1, further comprising at least one mirror or reflective prism mounted in the passenger compartment and coupled to the recorder, the mirror being configured to reflect the car-accident related events incident upon the recorder.

7. The system of claim 6, wherein the mirror is spaced from the housing of the standard car accessory.

8. The system of claim 6, wherein the mirror is mounted within the housing of the standard car accessory

9. The system of claim 1, wherein the mirror is configured to have a wide view angle.

10. The system of claim 9, wherein the mirror has a prismatically plane-shaped cross-section or dome concave/convex-shaped cross-section.

11. The system of claim 6, further comprising a sensory unit operative to detect the car-accident related events and generate a trigger signal in response to detection of the car-related events.

12. The system of claim 11, wherein the sensory unit comprises one or more sensors coupled to the camera and located within the housing of the standard accessory of the host vehicle or outside the housing.

13. The system of claim 11, wherein the one or more sensors are configured as an optical motion detector, an impact-acceleration detector or a deflection detector.

14. The system of claim 13, wherein the one or more sensors are selected from the group consisting of the optical operated configuration, acceleration or deflection operated configuration and a combination thereof.

15. The system of claim 12, wherein the one or more sensors are mounted to a body of the host vehicle.

16. The system of claim 11, further comprising a controller coupled to the recorder, the mirror and the sensory unit and operable to receive the triggering signal so as to generate a control signal actuating the recorder, wherein the controller is configured with a software or hardware.

17. The system of claim 16, wherein the controller is operative to execute an algorithm for actuating the recorder upon receiving the triggering signal from the sensory unit.

18. The system of claim 16, wherein the controller is operative to execute an algorithm for actuating the recorder to aim on a license plate region of a target vehicle.

19. The system of claim 16, wherein the controller is operative to execute an algorithm for displacing the mirror so as to have the car-accident related events reflected from a mirror incident upon the recorder.

20. The system of claim 16, wherein the controller is operative to execute an algorithm for recognizing icons on a license plate of a target vehicle and for generating a sound signal corresponding to each of the recognized icons, the system further comprising a transmitter linked to a remote information center and operable to transmit audio and video recordings of the car-related accident over a communication link.
